(19) United States
(12) Patent Application Publication
(10) Pub. No.: US 2017/0091780 A1
(43) Pub. Date: Mar. 30, 2017

(54) METHOD AND APPARATUS FOR FACILITATING CUSTOMER INTERACTIONS WITH ENTERPRISES

(71) Applicant: 24/7 Customer, Inc., Campbell, CA (US)

(72) Inventor: Pallipuram V. Kannan, Saratoga, CA (US)

(21) Appl. No.: 15/277,120

(22) Filed: Sep. 27, 2016

Related U.S. Application Data
(60) Provisional application No. 62/234,580, filed on Sep. 29, 2015.

(51) Int. Cl. G06Q 30/00; G06N 5/02; G06F 17/30

(52) U.S. Cl. CPC G06Q 30/016; G06F 17/30657; G06N 5/022

(57) ABSTRACT

A computer-implemented method and an apparatus facilitate linking of customer's enterprise-related interactions on non-enterprise related interaction channels to the enterprises. An enterprise-related query provided by a customer of the enterprise on a non-enterprise related interaction channel is received. An enterprise response to the query is provided to the customer on the non-enterprise related interaction channel. The provisioning of the enterprise response on the non-enterprise related interaction channel, at least in part, simulates an effect of provisioning of a reply by the enterprise to the query of the customer on an enterprise interaction channel.

### CROSS REFERENCE TO RELATED APPLICATIONS

This application claims priority to U.S. provisional patent application Ser. No. 62/234,580, filed Sep. 29, 2015, which is incorporated herein in its entirety by this reference thereto.

### TECHNICAL FIELD

The present technology generally relates to interactions between customers and enterprises, and more particularly to a method and apparatus for facilitating customer interactions with enterprises by linking customers and their queries on non-enterprise interaction channels with respective enterprises.

### BACKGROUND

Enterprises and their customers interact with each other for a variety of purposes. For example, enterprises may engage with existing customers and potential customers to draw their attention towards a product or a service, to provide information about an event of interest, to offer incentives or discounts, to solicit feedback, to provide billing related information and the like.

Similarly, the customers may initiate interactions with the enterprises to enquire about products/services of interest, to resolve concerns, to make payments, to lodge complaints and the like.

Typically, an interaction between a customer and an enterprise may involve one or more interaction channels. Examples of an interaction channel may include a web channel, a voice channel, a textual chat channel, an interactive voice response (IVR) channel, a social media channel, a native mobile application channel and the like.

Generally, a customer has to visit an enterprise website, open a native mobile application on the customer's device, or connect with a customer support representative via an interactive voice response (IVR) facility to initiate an interaction with an enterprise. More specifically, the customer has to dedicatedly visit an enterprise interaction channel to initiate an interaction with the enterprise, which may not always be convenient for the customer.

In an illustrative example, a customer may want to report a fraudulent transaction related to a banking enterprise. In such a scenario, the customer may visit a website of the banking enterprise to report the fraudulent transaction. Typically, the website of the banking enterprise may direct the customer to a toll free number of a customer support center to facilitate reporting of the fraudulent transaction. The customer may then call the toll-free number and wait in queue to speak to an agent and, once connected, the interaction may follow a prescribed path (as the interactions with the agents are typically based on scripts or menus), which can be very frustrating for the customer.

Therefore there is a need to facilitate customer interactions with enterprises while saving time and effort for the customer in connecting with the enterprises. Moreover, there is a need to connect the customer to the most appropriate interaction channel offered by the enterprise to improve a customer interaction experience.

### SUMMARY

In an embodiment of the invention, a computer-implemented method for facilitating customer interactions is disclosed. The method receives, by a processor, a query related to an enterprise. The query is provided by a customer of the enterprise on a non-enterprise related interaction channel. The method further causes, by the processor, a provisioning of an enterprise response to the query on the non-enterprise related interaction channel. The provisioning of the enterprise response on the non-enterprise related interaction channel, at least in part, simulates an effect of provisioning of a reply by the enterprise to the query of the customer on an enterprise interaction channel.

In another embodiment of the invention, an apparatus for facilitating customer interactions includes at least one processor and a memory. The memory stores machine executable instructions therein that, when executed by the at least one processor, cause the apparatus to receive a query related to an enterprise. The query is provided by a customer of the enterprise on a non-enterprise related interaction channel. The apparatus further causes a provisioning of an enterprise response to the query on the non-enterprise related interaction channel. The provisioning of the enterprise response on the non-enterprise related interaction channel, at least in part, simulates an effect of provisioning of a reply by the enterprise to the query of the customer on an enterprise interaction channel.

In another embodiment of the invention, a computer-implemented method for facilitating customer interactions is disclosed. The method receives, by a processor, a query related to an enterprise. The query is provided by a customer of the enterprise on a non-enterprise related interaction channel. The method predicts, by the processor, one or more intentions of the customer based, at least in part, on the query. The method causes, by the processor, a provisioning of an offer for interaction in response to the query on the non-enterprise related interaction channel based on the predicted one or more intentions of customers. Further, the method effects, by the processor, a transitioning of an interaction channel from the non-enterprise related interaction channel to an enterprise related interaction channel upon receiving an acceptance of the offer for interaction from the customer.

### BRIEF DESCRIPTION OF THE FIGURES

FIG. 1 is an example representation showing a customer seeking an answer to a query in accordance with an example scenario;

FIG. 2 is a block diagram of an apparatus configured to facilitate customer interactions with enterprises, in accordance with an embodiment of the invention;

FIG. 3 shows an example representation of a customer seeking an answer to an enterprise-related query on a non-enterprise related interaction channel for illustrating a facilitating of a customer interaction with an enterprise, in accordance with an embodiment of the invention;

FIG. 4 shows an example representation of a user interface (UI) displayed to a customer on a screen of a customer's device upon receiving an enterprise-related query input on a non-enterprise related interaction channel, in accordance with an embodiment of the invention;

FIG. 5 is a flow diagram of an example method for facilitating a customer interaction with an enterprise, in accordance with an embodiment of the invention; and

FIG. 6 is a flow diagram of an example method for facilitating a customer interaction with an enterprise, in accordance with another embodiment of the invention.

### DETAILED DESCRIPTION

The detailed description provided below in connection with the appended drawings is intended as a description of the present examples and is not intended to represent the only forms in which the present example may be constructed or used. However, the same or equivalent functions and sequences may be accomplished by different examples.

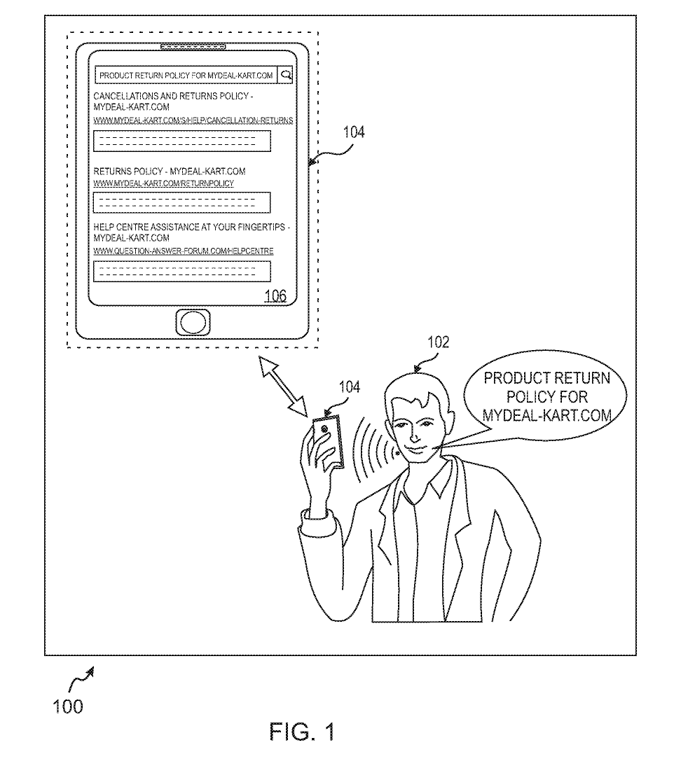

FIG. 1 is an example representation 100 showing a customer 102 seeking an answer to a query in accordance with an example scenario. In an illustrative example, the customer 102 may have recently purchased a product from an enterprise store and may want to return the product. The customer 102 may visit the enterprise website or contact the customer support representative to seek an answer to a product-return related query. Alternatively, the customer 102 may utilize a virtual assistant (VA) utility linked to a customer's device 104 (for example, an operating system related virtual assistant, such as ‘Siri®’ from Apple Inc.® or ‘Google Now™’ from Google® or ‘Cortana®’ from Microsoft Corporation® etc.) to seek assistance.

FIG. 1 depicts a scenario showing the customer 102 seeking assistance from the linked VA on the device 104. Accordingly, the customer 102 may type or speak ‘product return policy for Mydeal-kart.com’ to the linked VA. Upon receiving such a query, the VA may, in one example scenario, query a web search engine linked with the device 104 and provide the search results to the customer 102 as exemplarily displayed on a display screen 106 of the device 104 in FIG. 1.

The customer 102 may choose a result, such as for example a result displaying text ‘Cancellations and returns policy—Mydeal-kart.com’ from among the displayed search engine results to seek an answer to the query. Such assistance, though useful, is of limited help to the user. In case, the customer 102 is not satisfied with the information provided on a web page associated with the chosen search result, then the customer 102 may contact the customer support centre and seek to speak to an agent for receiving an answer to the query, which is cumbersome for the user.

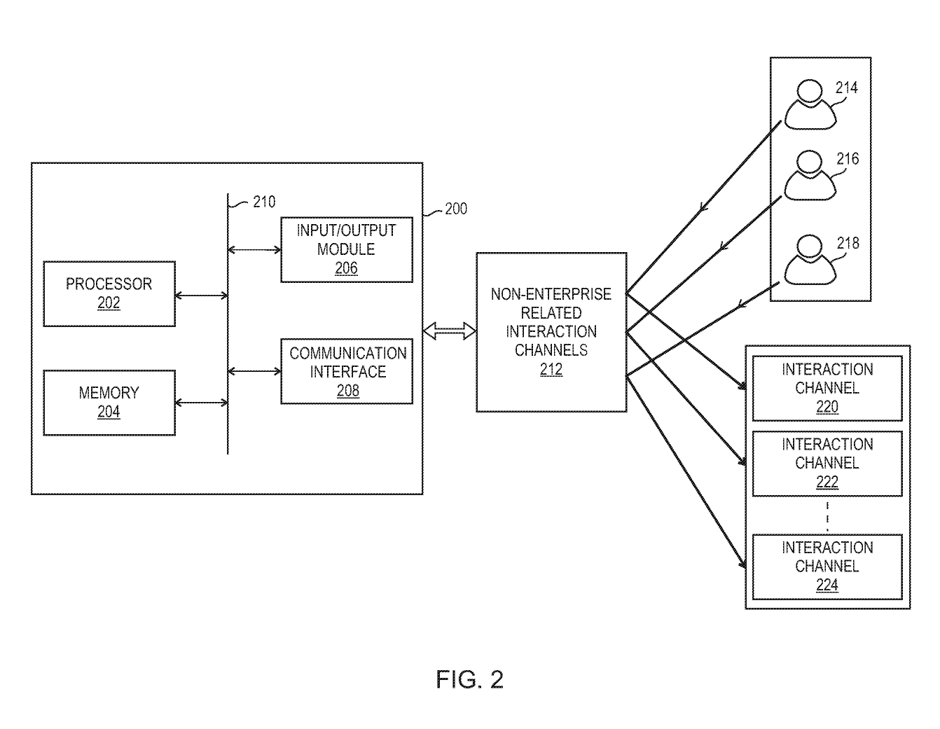

Various embodiments of the present technology provide a method and apparatus that are capable of overcoming these and other obstacles and providing additional benefits. More specifically, various embodiments of the present technology disclosed herein facilitate customer interactions with enterprises by directly linking customers and their enterprise-related queries on third-party websites and/or applications to corresponding enterprises for facilitating customer interactions with enterprises. An example apparatus for facilitating customer interactions with enterprises is explained with reference to FIG. 2.

FIG. 2 is a block diagram of an apparatus 200 configured to facilitate customer interactions with enterprises, in accordance with an embodiment of the invention. The term ‘customer’ as used herein refers to either an existing user or a potential user of enterprise offerings such as products, services and/or information. Moreover, the term ‘customer’ of the enterprise may refer to an individual, a group of individuals, an organizational entity etc. The term ‘enterprise’ as used herein may refer to a corporation, an institution, a small/medium sized company or even a brick and mortar entity. For example, the enterprise may be a banking enterprise, an educational institution, a financial trading enterprise, an aviation company, a consumer goods enterprise or any such public or private sector enterprise. Moreover, the term ‘interaction’ or ‘customer interaction’ as used interchangeably herein refers to any communication and/or exchange between a customer and an enterprise related entity, such as for example an enterprise website, a customer support representative of the enterprise and the like. For example, a customer activity of browsing through web pages of an enterprise website may be considered as an interaction between the customer and the enterprise for purposes of the description. In another illustrative example, a customer activity of engaging in a voice call interaction or a chat interaction with a human agent associated with the enterprise may be considered as an interaction between the customer and the enterprise. In yet another illustrative example, the activity of using enterprise self-help tools, such as for example an IVR system, by the customer may also be considered as an interaction between the customer and the enterprise. Accordingly, any such form of communication or exchange between a customer and an enterprise related entity is referred to herein as the customer interaction.

The apparatus 200 includes at least one processor, such as a processor 202 and a memory 204. It is noted that although the apparatus 200 is depicted to include only one processor, the apparatus 200 may include more number of processors therein. In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.).

The apparatus 200 also includes an input/output module 206 (hereinafter referred to as ‘I/O module 206’) and a communication interface 208. The I/O module 206 is configured to facilitate provisioning of an output to a user of the apparatus 200. In an embodiment, the I/O module 206 may be configured to provide a user interface (UI) configured to provide options or any other display to the user. The I/O module 206 may also include mechanisms configured to receive inputs from the user of the apparatus 200. The I/O module 206 is configured to be in communication with the processor 202 and the memory 204. Examples of the I/O module 206 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication interface 208 is configured to enable the apparatus 200 to communicate with other entities, such as for example, remote data gathering servers. The remote data gathering servers may collate information from a plurality of interaction channels and/or a plurality of devices utilized by the customers for interacting with an enterprise, for example Enterprise ‘E’. To that effect, the remote data gathering servers may be in operative communication with various customer touch points, such as the electronic devices associated with the customers, website and/or native mobile application of the enterprise ‘E’ visited by the customers, the customer support representatives (for example, voice-agents, chat-agents, IVR systems and the like, associated with the enterprise ‘E’) engaged by the customers and the like. In at least some embodiments, the communication interface 208 may include relevant application programming interfaces (APIs) to communicate with the remote data gathering servers. Moreover, the communication between the communication interface 208 and the remote data gathering servers may be realized over various types of wired or wireless networks.

In at least one example embodiment, the apparatus 100 is configured to receive up-to-date information on the customers of an enterprise, for example enterprise ‘E’ and their enterprise related interaction activity, using the communication interface 208. In an embodiment, the information received for each customer includes profile data and interaction data corresponding to respective customer's interactions with the enterprise. A customer's profile data may include profile information related to the customer, such as for example, a customer's name and contact details, information relating to products and services associated with the customer, social media account information, information related to other messaging or sharing platforms used by the customer, recent transactions, customer interests and preferences, customer's credit history, history of bill payments, credit score, memberships, history of travel, and the like. In some exemplary embodiments, the customer information may also include calendar information associated with the customer. For example, the calendar information may include information related to an availability of the customer during the duration of the day/week/month.

In an embodiment, interaction data received corresponding to a customer may include information such as enterprise ‘E’ related web pages visited, queries entered, chat entries, purchases made, exit points from websites visited, decisions made, mobile screens touched, work flow steps completed, sequence of steps taken, engagement time, IVR speech nodes touched, IVR prompts heard, widgets/screens/buttons selected or clicked, historical session experience and results, customer relationship management (CRM) state and state changes, agent wrap-up notes, speech recordings/transcripts, chat transcripts, survey feedback, channels touched/used, sequence of channels touched/used, instructions, information, answers, actions given/performed by either enterprise system or agents for the customer, and the like. In some example scenarios, the interaction data may include information related to past interactions of the customer with resources at a customer support facility, the types of channels used for interactions, customer channel preferences, types of customer issues involved, whether the issues were resolved or not, the frequency of interactions and the like.

The communication interface 208 is configured to facilitate reception of such information related to the customers in real-time or on a periodic basis. Moreover, the information may be received by the communication interface 208 in an online mode or an offline mode. In an embodiment, the communication interface 208 provides the received information to the memory 204 for storage purposes. In an embodiment, the information related to each customer is labeled with some customer identification information (for example, a customer name, a unique ID and the like) prior to storing the information in the memory 204.

In an embodiment, the apparatus 200 may be configured to be in operative communication with non-enterprise related interaction channels, exemplarily depicted as non-enterprise related interaction channels 212 in FIG. 2, through the communication interface 208. The term ‘non-enterprise related’ (also interchangeably referred to as ‘third party’) as used herein refers to an entity that is not related to an enterprise linked to the apparatus 200. For example, the apparatus 200 may be linked with an organization ‘ABC’ involved in assisting travelers to book airline reservations. Any enterprise not linked with the organization ‘ABC’ may be deemed as ‘non-enterprise related’ or ‘third-party’ by the apparatus 200. Accordingly, the non-enterprise related interaction channels 210 may include the entire gamut of websites/applications barring those linked with enterprises associated with the apparatus 200. More specifically, a non-enterprise related interaction channel may be one of a third-party website, a third-party native mobile application, a third-party messaging platform, a device-based virtual assistant application and a search engine related user interface (UI). In an illustrative scenario, a third-party website may be a website related to any other organization other than the organization ‘ABC’ linked to the apparatus 200. Similarly, a third-party native mobile application may be a mobile device application related to any other organization other than the organization ‘ABC’ linked to the apparatus 200. For example, the third-party website or the third-party native mobile application may correspond to a social networking website such as Facebook®, Google Circles™, and the like. Some non-exhaustive examples of third-party messaging platforms may include Facebook Chat, Hangouts™, WhatsApp™ and any other such instant messaging platforms. Some non-exhaustive examples of search engine related UIs may include UIs corresponding to search engines such as Google®, Yahoo!®, Bing® and the like. An example of a device-based virtual assistant application, may include but is not limited to VAs, such as Siri®, Google Now™, Cortana® and the like.

In an embodiment, various components of the apparatus 200, such as the processor 202, the memory 204, the I/O module 206 and the communication interface 208 are configured to communicate with each other via or through a centralized circuit system 210. The centralized circuit system 210 may be various devices configured to, among other things, provide or enable communication between the components (202-208) of the apparatus 200. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

It is understood that the apparatus 200 as illustrated and hereinafter described is merely illustrative of an apparatus that could benefit from embodiments of the invention and, therefore, should not be taken to limit the scope of the invention. It is noted that the apparatus 200 may include fewer or more components than those depicted in FIG. 2. In an embodiment, the apparatus 200 may be implemented as a platform including a mix of existing open systems, proprietary systems and third party systems. In another embodiment, the apparatus 200 may be implemented completely as a platform including a set of software layers on top of existing hardware systems. In an embodiment, one or more components of the apparatus 200 may be deployed in a web server. In another embodiment, the apparatus 200 may be a standalone component in a remote machine connected to a communication network and capable of executing a set of instructions (sequential and/or otherwise) so as to facilitate customer interactions with enterprises. Moreover, the apparatus 200 may be implemented as a centralized system, or, alternatively, the various components of the apparatus 200 may be deployed in a distributed manner while being operatively coupled to each other. In an embodiment, one or more functionalities of the apparatus 200 may also be embodied as a client within devices, such as customers' devices. In another embodiment, the apparatus 200 may be a central system that is shared by or accessible to each of such devices.

The facilitating of customer interactions with the enterprises by the apparatus 200 is hereinafter explained with reference to one customer. It is noted the apparatus 200 may be caused to facilitate, or more specifically, to link several customers and their enterprise-related queries with the respective enterprises in a similar manner.

In at least one example embodiment, the processor 202 is configured to, with the content of the memory 204, cause the apparatus 200 to receive a query related to an enterprise provided by a customer of the enterprise on a non-enterprise related interaction channel. As explained with reference to FIG. 1, a customer of the enterprise corresponds to any existing user or potential user of an enterprise offering, such as for example, a product, a service or even information offered by the enterprise. In an embodiment, the query related to the enterprise may be a text-based query or a verbal query. Further, as explained above, a non-enterprise related interaction channel may be a third-party website, a third-party native mobile application, a third-party messaging platform, a device-based virtual assistant application, a search engine related user interface (UI) and the like. In an illustrative example, a customer may currently be interacting with a third party application or a third party website and seek an answer for an enterprise-related query on the third party application or the third party website itself. For example, the customer may be browsing through a ‘Q&A’ discussion forum on the web and seek answer for the enterprise-related query on the forum. Alternatively, the customer may invoke a third party application, such as a VA, and seek answer for the enterprise-related query. In FIG. 2, three customers 214, 216 and 218 are exemplarily depicted to seek answers to respective enterprise-related queries on non-enterprise related interaction channels 212.

In an embodiment, the non-enterprise related interaction channels 212 may be configured to link queries to corresponding enterprises. In an illustrative example, a customer of a banking enterprise may provide a query related to a prepayment of a home loan on a non-enterprise related interaction channel. The non-enterprise related interaction channel may be configured to parse the query and identify words like the name of the banking enterprise or terms like ‘prepayment’ or ‘home loan’ and may link the query to the banking enterprise. The non-enterprise related interaction channel may further be configured to provision the query related to the banking enterprise to the apparatus 200 as the apparatus 200 is linked to the banking enterprise. In some embodiments, the non-enterprise related interaction channel may also provision any customer identification information along with current channel journey information to the apparatus 200. For example, the non-enterprise related interaction channel may provision any relevant information such as IP address, query timing information, phone information, device browser/operating system information etc., which may enable the apparatus 200 to identify the customer.

In an embodiment, the apparatus 200 on account of being in operative communication with the non-enterprise related interaction channels 212 may be configured to receive the customer queries along with respective customer identification information through the communication interface 208 and provide the received information to the processor 202.

In at least one example embodiment, the processor 202 may be caused to initiate a search in the memory 204 to identify the customer based on the query and other customer identification information. For example, the processor 202 may be caused to compare and match IP address, phone number, device browser/operating system or any such information, individually or in combination, with stored information related to a plurality of customers of the enterprise to identify the customer. In most cases, the information stored in the memory 204 may facilitate identification of the customer. However, in some scenarios, the customer may be a first-time user or a potential customer and, as such, no information may be available in the memory 204.

In at least one example embodiment, the apparatus 200 may be caused to predict the one or more intentions for the customer based on the query and/or the stored information related to the customer. More specifically, if the customer is a potential customer or a first time user, then the apparatus 200 may be caused to predict intention(s) of the customer based on the query itself and any information related to the current journey of the customer on a non-enterprise related interaction channel. However, if the customer is an existing customer, then the apparatus 200 may be caused to predict intention(s) of the customer based on the query and stored information corresponding to past interactions of the customer with the enterprise. In an illustrative example, if the customer query relates to a flight cancellation policy and stored information of the customer suggests that the customer has recently purchased a flight ticket, then the processor 202 may be configured to predict that the customer may want to cancel the flight reservation for the recently purchased flight ticket. Similarly, if the stored calendar information suggests that the customer is traveling overseas next week and the customer query relates to an enquiry for travel insurance then the processor 202 may be configured to predict that the customer is considering purchasing travel insurance for that particular overseas trip.

In an embodiment, for customer intention prediction purposes, the memory 204 stores one or more prediction models (not shown in FIG. 2), which are configured to subject the query and any previously gathered information corresponding to the customer to a set of structured and un-structured data analytical models including text mining & predictive models. Examples of the prediction models may include, but are not limited to Logistic regression, Naïve Bayesian, Rule Engines, Neural Networks, Decision Trees, Support Vector Machines, k-nearest neighbor, K-means and the like. In an embodiment, the prediction models may be configured to extract features from the query and any previously gathered information and provision the features to the prediction models. Examples of the features that may be provisioned to the prediction models may include, but are not limited to, any combinations of words features such as n-grams, unigrams, bigrams and trigrams, word phrases, part-of-speech of words, sentiment of words, sentiment of sentences, position of words, customer keyword searches, customer click data, customer web journeys, cross-channel journeys, call-flow, the customer interaction history and the like. In an embodiment, the prediction models may utilize any combination of the above-mentioned input features to predict the customer's likely intention. In some embodiments, the intention can be inferred and or predicted, based on prior or current activity, or can be specifically indicated by the customer. In some embodiments, machine learning and other artificial intelligence (AI) techniques may be used to monitor the predictions and the customer responses in order to improve the predictions.

In an embodiment, the apparatus 200 is also configured to receive at least one of channel presence information and current channel attention information from the linked customer devices. In an illustrative example, the customer may have logged into a native mobile application and may also be browsing one or more websites. In such a scenario, the customer's presence in the native mobile application channel and the web channel may be recorded as the channel presence information.

More specifically, a customer login to a native mobile application (or in some scenarios, even activating the native mobile application on the device) may be tracked (for example, using JavaScript tags) by the customer's device. Such information may be communicated, in substantially real-time, by the native mobile application using APIs to a device transceiver to communicate the login/activation information to the communication interface 208 of the apparatus 200. The processor 202 upon receiving such information from the communication interface 208 may be configured to record the customer's presence in the native mobile application interaction channel. Similarly, a customer access and subsequent activity on a website may be tracked using Web browser cookies or Hyper Text Markup Language (HTML) tags by a Web server hosting the enterprise website. The Web server may be configured to communicate such information to the communication interface 208 in substantially real-time. The processor 202 upon receiving such information from the communication interface 208 may record the customer's presence in the Web interaction channel.

Further, even though the customer is present in one or more interaction channels, the interaction channel that the customer is currently attentive to is recorded as the current channel attention information. In an illustrative example, even though the customer has logged in one or more social media accounts, the customer may be currently browsing a website (as indicated by activated HTML or JavaScript tags or browser cookies), then the apparatus 200 is caused to determine the current channel attention information as the web interaction channel (and not social media interaction channel).

Furthermore, the apparatus 200 may be configured to receive at least one of customer location information and query timing information from the non-enterprise related interaction channels 212 or directly from the linked customer devices. For example, the communication interface 208 may be caused to obtain the location of the customer from the customer device, which may, for example, detect the location of the customer using a global positioning system (GPS) or other triangulation techniques and provide such location information to the communication interface 208. The location of the customer may also be determined by a native application that is running on the customer device. The native application may work independently or in coordination with systems operated by the telecommunications provider to facilitate location determination.

In at least one example embodiment, the apparatus 200 may be caused to utilize the predicted intention(s) along with information such as channel presence/attention information, location information, query timing information etc. to determine the most appropriate enterprise response to be provided to the customer as a reply to the customer query. To that effect, the processor 202 may be configured to predict the next best action for the customer. In an embodiment, the best next action is predicted based on an analysis of the lowest effort sequence of tasks, interactions, and information that can get the customer to their intended goal. In an embodiment, the prediction of the best next action is based on corporate policy, for example, to provide product and service information, to offer product and service incentives, and the like. In an embodiment, the prediction of the best next action is influenced by enterprise objectives. Some non-exhaustive examples of enterprise objectives include increasing consumption of enterprise offerings and improving customer sales and service experience. For example, the customer's profile data and interaction data may be analyzed to determine the guidance and influence steps to be performed to keep the customer engaged or to facilitate consumption of goods/services by the customer. In an embodiment, the guidance and influence steps are not based on a fixed or standard support ‘menu’, for example, but instead are predicted dynamically for the particular customer. The prediction of the best next action can be based on considering and evaluating some or all of the criteria mentioned above.

In an embodiment, the apparatus 200 may be caused to retrieve one or more past actions of the customer from the stored past information based on a relevance of the one or more past actions to the current information, and determine at least one next action based on the one or more past actions of the customer. For example, if the current information relates to a meeting cancelation event, then the apparatus 200 may be caused to retrieve previous actions of the customer in response to such an event. For example, the customer may have previously rescheduled the meeting as a web conference and sent invitations to mobile devices of probable attendees based on confirmed availability. Accordingly, the apparatus 200 may be caused to predict the next actions to be rescheduling the meeting as a web conference at a time when the probable attendees are free to attend the meeting and then sending invites to the probable attendees of the web conference.

In some embodiments, the apparatus 200 may be caused to identify relevant actions of customers associated with profiles similar to a profile of the customer and determine the next action based on the identified actions. For example, if the current information relates to a fraudulent card transaction event, then the apparatus 200 may be caused to identify actions of other customers, who have similar profile (for example, similar age, profession, travel preferences, etc.) as that of the customer for such an event and determine one or more next actions based on the identified actions of the other customers. For example, other customers with similar profile as that of the customer may have canceled their credit card and ordered a replacement credit card. Accordingly, the apparatus 200 may be caused to determine the next actions to be cancelation of the card and ordering of a replacement card.

In an embodiment, a best next action predicted by the apparatus 200 may correspond to at least one of rebooking a flight reservation, paying a bill, making a hotel reservation, making a car rental reservation, making a restaurant reservation, purchasing one or more tickets to an event (such as a game, movie screening, theater presentation etc.), purchasing a product, initiating contact with an emergency service provider, seeking technical support, troubleshooting a concern, rescheduling one or more appointments, accessing a map location to search for one or more preferred locations near a current location of the customer and the like. In an embodiment, the best next action may relate to a financial transaction, such as an action related to fraud prevention, proactive offer of payment splitting and/or payment rescheduling, credit card cancelation, seeking a replacement credit card and so on and so forth.

In at least one example embodiment, the processor 202 is configured to, with the content of the memory 204, cause the apparatus 200 to cause a provisioning of an enterprise response to the query on the non-enterprise related interaction channel. More specifically, the processor 202 may determine the most appropriate enterprise response based on the predicted one or more intentions or the predicted best next action, and thereafter the processor 202 may provision the enterprise response to the communication interface 208. The communication interface 208, using associated transceiver circuitry, may be configured to provision the enterprise response, over a communication network (for example, a wired and/or wireless network) to a customer device associated with the non-enterprise related interaction channel. The customer device may then be configured to provision the enterprise response (for example, by displaying the enterprise response on a display screen) to the customer on the non-enterprise related interaction channel. The provisioning of the enterprise response on the non-enterprise related interaction channel is configured to simulate an effect of provisioning of a reply by the enterprise to the query of the customer on an enterprise interaction channel. More specifically, the enterprise response may be provided to the customer on the non-enterprise interaction channel in a manner the customer would have been provided, had the customer provisioned the query on an enterprise interaction channel. In effect, the provisioning of the query on the non-enterprise interaction channel may be treated as provisioning the query on an enterprise interaction channel and the enterprise response would be provided to the customer in a similar manner as that would have been provided had the customer provisioned the query on an enterprise interaction channel. For example, a banking enterprise's response to a customer query on a third-party website may be provisioned in a manner similar to provisioning of responses to such customer queries on the banking enterprise's website. In effect, the customer is directly linked to the banking enterprise's website and does not require dedicated access to the banking enterprise website to seek assistance.

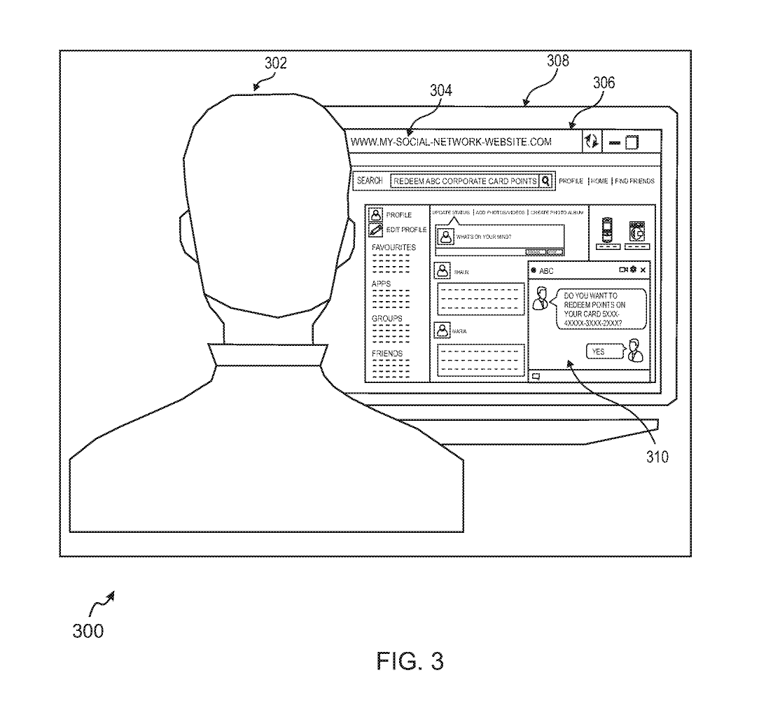

In an embodiment, the provisioning of the enterprise response includes provisioning of an answer to the query or an offer for interaction with a customer support representative of the enterprise in response to the query of the customer. In some embodiments, the apparatus 200 may be caused to provide the most appropriate response to the customer query using the non-enterprise related interaction channel and initiate an interaction with the customer on the non-enterprise related interaction channel itself. Such a scenario is explained later with reference to FIG. 3.

Alternatively, the apparatus 200 may be caused to provision an offer to interact with a customer support representative of the enterprise on an enterprise interaction channel. To that effect, the processor 202 may be configured to predict the most appropriate enterprise interaction channel for the customer for continuing the interaction. For example, given the nature of the interaction, if a voice medium is better mode of interaction than the currently preferred chat medium, then the apparatus 200 may suggest switching the interaction to the voice medium to facilitate the interaction. In at least one example embodiment, the apparatus 200 is configured to choose the enterprise related interaction channel for transitioning the interaction based on stored customer channel preference or prediction of appropriate interaction channel for the interaction. In an embodiment, the apparatus 200 may be caused to select an enterprise interaction channel, which is determined to provide maximum benefit to the customer. In an embodiment, an interaction channel determined to meet one or more predefined enterprise objectives is selected from among a plurality of interaction channels. Some non-limiting examples of the predefined enterprise objectives may include a sales objective, a service objective, an influence objective and the like. The sales objective may be indicative of a goal of increasing sales revenue of the enterprise. The service objective may be indicative of a motive of improving interaction experience of the customer, whereas the influence objective may be indicative of the motive of influencing a customer into making a purchase.

In some embodiments, the apparatus 200 may effect a transitioning of the interaction from the non-enterprise related interaction channel to an enterprise related interaction channel upon receiving an acceptance of the offer for interaction from the customer. In an illustrative example, the apparatus 200 is caused to effect a passing of at least one of an authentication information (for example, information configured to facilitate customer identification and authentication) and an interaction context information (for example, information collated corresponding to the ongoing customer interaction so far) from the non-enterprise interaction channel to the enterprise interaction channel. In an embodiment, the data gathering servers associated with the non-enterprise interaction channels may be configured to identify and tag the customer and their context, e.g. history, past behavior, steps progressed, obstacles and/or issues encountered, etc., uniquely. In an embodiment, the unique identifiers may be used to create linkages across interaction channels and devices. Examples of various unique identifiers may include, but are not limited to IP address, Web cookies, third party Web cookies, order IDs, request IDs, various personally identifiable information (PII), mobile device identifiers, and the like. The creating, passing, and matching of unique identifiers enables the seamless transfer of context, experience, history, action, information, and identification between the separate interaction channels that customers typically use to engage with enterprises and/or businesses.

In an illustrative example, the interaction may be transitioned from a VA, i.e. a non-enterprise related interaction channel, to an IVR system associated with the enterprise upon customer acceptance for an offer for interaction. The transitioning may be effected by passing unique identifiers (identifying the customer) along with passing of interaction context from the VA, i.e. from the customer's device hosting the VA, to the processor 202 over a communication network. The processor 202 may then be caused to provision a Web link or a clickable widget on the customer device, which upon being accessed may cause the customer device to be connected to the IVR system associated with the enterprise to transition the interaction. In FIG. 2, the customers 214, 216 and 218 are exemplarily depicted to have transitioned from the non-enterprise related interaction channels 212 to the enterprise, or more specifically to the enterprise interaction channels 220, 222 and 224, respectively.

The linking of customer and their queries to the enterprise, as explained above, saves the customer both time and effort as the customer does not have to dedicatedly access the enterprise interaction channel and seek desired information. Moreover, in many example scenarios, the customer does not have to wait in queue to speak to an agent or does not have to wade through the lengthy question-answer forums to seek answer to their queries. Moreover, such a manner of linking the customer to the enterprise interaction channel creates an interaction ecosystem within the third party application/website enabling the customer to interact with the enterprise within the third party application/website. An example scenario for illustrating a facilitating of customer interaction with an enterprise is explained with reference to FIG. 3.

FIG. 3 shows an example representation 300 of a customer 302 seeking an answer to an enterprise-related query on a non-enterprise related interaction channel for illustrating a facilitating of a customer interaction with an enterprise, in accordance with an embodiment of the invention. More specifically, the example representation 300 depicts a customer 302 accessing a third-party website ‘WWW.MY-SOCIAL-NETWORK-WEBSITE.COM’ (hereinafter referred to as website 304) using a web browser application 306 installed on a desktop computer 308. In an example scenario, the website 304 relates to a social networking website displaying a message feed, customer profile related option and one or more menu options for interacting with the website 304. The website 304 may include a search box for enabling the customer 302 to input text for searching for desired information on the website 304. In an example scenario, the customer 304 may input text ‘REDEEM ABC CORPORATE CARD POINTS’. In an example embodiment, the communication interface 208 of the apparatus 200 may be operative communication with a web server hosting the website 304. The web server may be configured to direct any query input related to enterprise ABC to the communication interface 208 in substantially real-time (or more specifically, with minimal delay, for example of the order of milliseconds).

The apparatus 200 may be configured to treat any enterprise related query input provisioned on a non-enterprise related interaction channel as if it was received on an enterprise related interaction channel. The apparatus 200 may seek to identify the customer and thereafter predict customer intent based on the query and/or using any stored information related to the customer 302. For example, the apparatus 200 may predict that the customer is considering redeeming points on his/her corporate card and needs assistance for redeeming the points. The processor 202 of the apparatus 200 may retrieve the card information of the customer's corporate card stored in the memory 204, such as for example card number, card expiration details, card policy etc. The processor 202 may also cause an opening of a chat window 310 in the website 304 to facilitate customer's interaction with a chat agent associated with the enterprise. The chat window 304 may display a chat message ‘Do you want to redeem points on your card 5xxx-4xxxx 3xxx 2xxx?’ If the customer responds with a ‘yes’, then the chat agent may assist the customer 302 through the steps for redeeming points on the customer corporate card.

In another example scenario, the chat agent may offer to arrange a phone call from another agent entrusted with assisting customers with redeeming points on their cards, so that the customer may directly provide a request for redeeming points to the agent. Alternatively, the chat agent may provide a web-link for accessing the web page where the user can provide a request for redeeming points. In another example scenario, the chat agent may offer attractive schemes for exchanging points for goods/services sold by the enterprise or partners of the enterprise.

In an illustrative example, the customer 302 may have recently been browsing websites for planning a vacation in Europe. The processor 202 may determine promotional offers related to such a travel in exchange of the points and suggest the same to the customer 302. It is understood that different responses may be provided to the customer 302 on the website 304 (i.e. on the non-enterprise related interaction channel) and/or the customer may be connected to the enterprise interaction channel on the website 304 itself, thereby improving customer experiences.

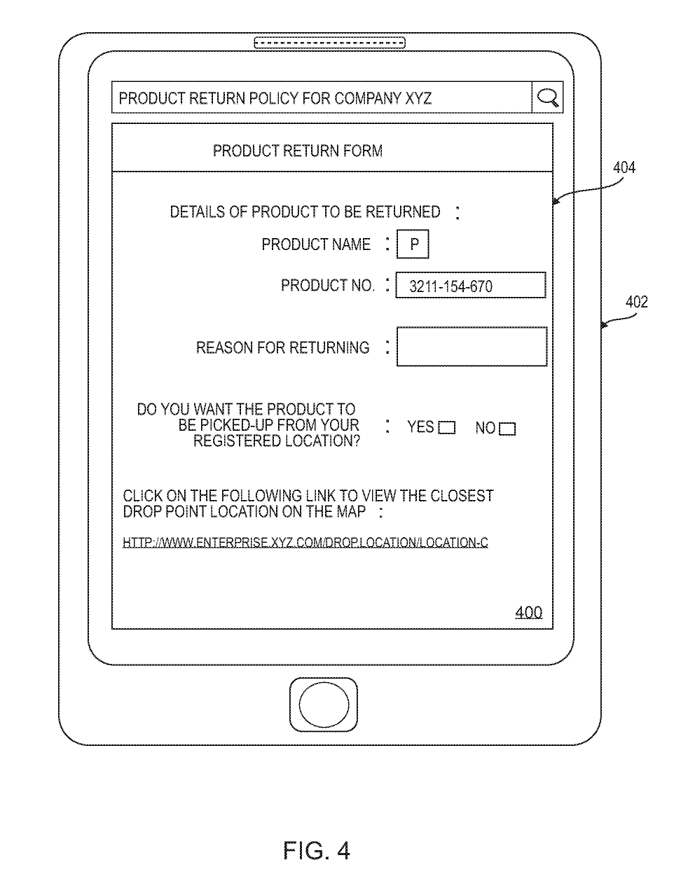

Another example scenario for illustrating a facilitating of customer interaction with an enterprise is explained with reference to FIG. 4.

FIG. 4 shows an example representation of a user interface (UI) 400 displayed to a customer on a screen of a customer's device 402 upon receiving an enterprise-related query input on a non-enterprise related interaction channel, in accordance with an embodiment of the invention. In an example scenario, a customer may utilize a virtual assistant or a VA utility within the customer's device 402 (for example, an operating system related virtual assistant, such as ‘Siri®’ from Apple Inc.® or ‘Google Now™’ from Google® or ‘Cortana®’ from Microsoft Corporation® etc.) to seek assistance for a query. For example, the customer may type or speak ‘product return policy for company XYZ’ to the linked VA.

In an example embodiment, the communication interface 208 of the apparatus 200 may be operative communication with the VA, which may be configured to direct any query input related to enterprise XYZ to the communication interface 208 in substantially real-time (or more specifically, with minimal delay, for example of the order of milliseconds). As explained above, the apparatus 200 may be configured to treat any enterprise related query input provisioned on a non-enterprise related interaction channel as if it was received on an enterprise related interaction channel.

Upon receiving the customer query, the apparatus 200 may be configured to predict customer intent based on the query and the stored information related to the customer. For example, the apparatus 200 may predict that the customer is considering returning a recently purchased product ‘P’. The processor 202 of the apparatus 200 may retrieve information related to the product ‘P’, such as product name, purchase price, date of purchase, return policy associated with product ‘P’ and the like. In one embodiment, in response to the query to the linked VA, the processor 202 may be configured to display a product return form 404 on the UI 400 of the customer device 402. In an example scenario, the product return form 404 may include some pre-filled information such as the identification of the product to be returned, i.e. Product ‘P’ and some other form fields, such as reason for returning the product and preferred option of pick-up from registered location and the like, as displayed in the product return form 404. Alternatively, the customer may click on the link to view the closest drop location from the customer's current location. Thus, the customer does not have to wait to speak to an agent but instead fill-out the form and request a product return directly from the linked VA itself. It is noted that different responses may be provided to the customer in response to the query to the linked VA. For example, the customer may be offered a link to open an enterprise native mobile application, which may direct the customer to the enterprise's FAQ section outlining the product return policy of the company XYZ. In some embodiments, the processor 202 may display a widget on the UI 400 requesting the customer for an interaction with an IVR or a live agent to facilitate returning of the product. Thus, the customer may be provided with a suitable response to the query on the third party application or the non-enterprise related interaction channel, such as the VA itself, or may be connected to the enterprise interaction channel through the VA, thereby improving customer experiences.

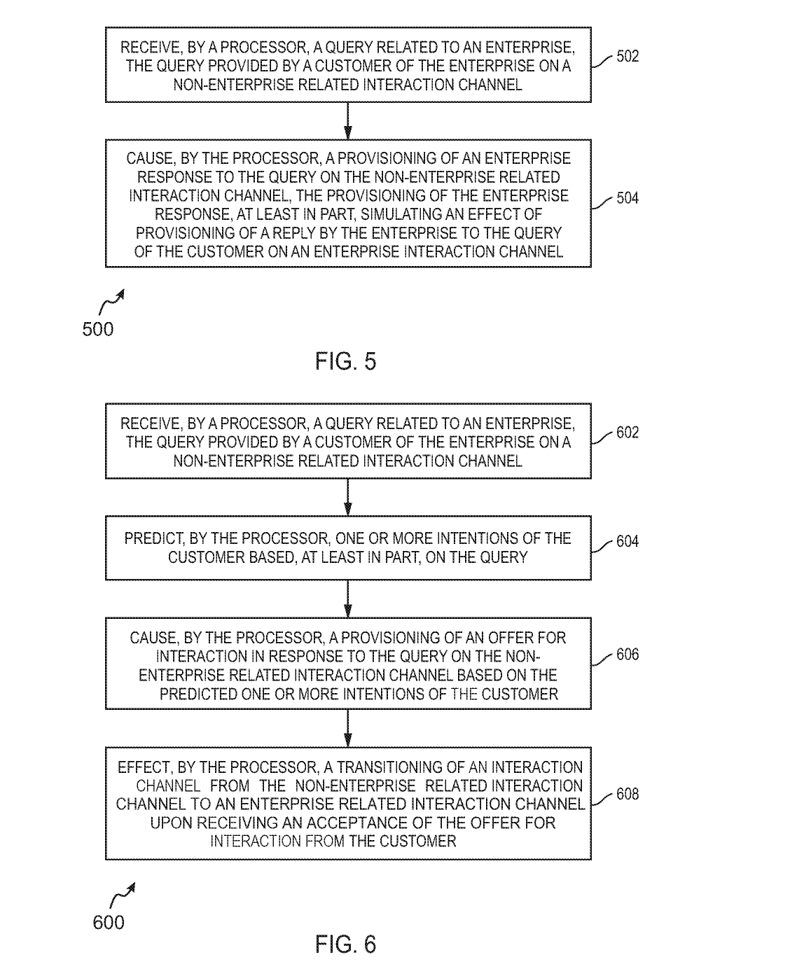

A method for facilitating a customer interaction with an enterprise is explained with reference to FIG. 5.

FIG. 5 is a flow diagram of an example method 500 for facilitating a customer interaction with an enterprise, in accordance with an embodiment of the invention. The method 500 depicted in the flow diagram may be executed by, for example, the apparatus 200 explained with reference to FIGS. 2 to 4. Operations of the flowchart, and combinations of operation in the flowchart, may be implemented by, for example, hardware, firmware, a processor, circuitry and/or a different device associated with the execution of software that includes one or more computer program instructions. The operations of the method 500 are described herein with help of the apparatus 200. For example, one or more operations corresponding to the method 500 may be executed by a processor, such as the processor 202 of the apparatus 200. It is noted that although the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 500 can be described and/or practiced by using an apparatus other than the apparatus 200. The method 500 starts at operation 502.

At operation 502 of the method 500, a query related to an enterprise is received for example, by a processor, such as the processor 202 of the apparatus 200. The query is provided by a customer of the enterprise on a non-enterprise related interaction channel. As explained with reference to FIG. 1, a customer of the enterprise corresponds to any existing user or potential user of an enterprise offering, such as for example, a product, a service or even information offered by the enterprise. In an embodiment, the query related to the enterprise may be a text-based query or a verbal query. Further, as explained above, a non-enterprise related interaction channel may be a third-party website, a third-party native mobile application, a third-party messaging platform, a device-based virtual assistant application, a search engine related user interface (UI) and the like. An example provisioning of query is explained with reference to FIG. 1.

In an embodiment, the non-enterprise related interaction channels may be configured to link the query to a corresponding enterprise. In an illustrative example, a customer of a telecom company may provide a query related to a new voice and data plan on a non-enterprise related interaction channel. The non-enterprise related interaction channel may be configured to parse the query and identify words like the name of the telecom company or terms like ‘voice’ or ‘data plan’ and may link the query to the telecom company. The non-enterprise related interaction channel may further be configured to provision the query to the processor. In some embodiments, the non-enterprise related interaction channel may also provision any customer identification information along with current channel journey information to the processor. For example, the non-enterprise related interaction channel may provision any relevant information such as IP address, query timing information, phone information, device browser/operating system information etc., which may enable identification of the customer.

At operation 504 of the method 500, a provisioning of an enterprise response to the query on the non-enterprise related interaction channel is caused by the processor. In an embodiment, the enterprise response, i.e. either an answer to the query or an offer for interaction with an agent, may be provisioned by the processor using a communication interface, such as the communication interface 208 explained with reference to FIG. 2, to the customer device associated with the non-enterprise interaction channel. The customer device may then be configured to provision the enterprise response, for example by displaying the enterprise response, to the customer on the non-enterprise interaction channel.

In an embodiment, one or more intentions of the customer may be predicted based on the query or stored past information corresponding to the customer. Furthermore, one or more best next actions may be determined in response to the customer's query as explained with reference to FIG. 2. The processor may further be configured to determine the most appropriate enterprise response based on the predicted one or more intentions or the predicted best next action, and thereafter provision the enterprise response to the customer on the non-enterprise related interaction channel. The provisioning of the enterprise response on the non-enterprise related interaction channel is configured to simulate an effect of provisioning of a reply by the enterprise to the query of the customer on an enterprise interaction channel. More specifically, the enterprise response may be provided to the customer on the non-enterprise interaction channel in a manner the customer would have been provided, had the customer provisioned the query on an enterprise interaction channel. In effect, the provisioning of the query on the non-enterprise interaction channel may be treated as provisioning the query on an enterprise interaction channel and the enterprise response would be provided to the customer in a similar manner as that would have been provided had the customer provisioned the query on an enterprise interaction channel.

In embodiments of the invention. the processor may comprise a platform that serves to act on behalf of the enterprise. For example, if the customer visits the enterprise website, the provisioning of a chat offer or answering a query, for example by sending a Web link, or any such assistance is handled by the platform. The platform receives the query on behalf of the enterprise and provides a response as it would have provided on the enterprise website. However, the response is not provided on the enterprise channel but is provided by the platform on a non-enterprise channel. The transfer of the response to the non-enterprise channel is performed by the platform using the communication interface, which sends response to the customer device using transceiver circuitry (as discussed above).

In an embodiment, the provisioning of the enterprise response comprises provisioning of an answer to the query or an offer for interaction with a customer support representative of the enterprise in response to the query of the customer. In some embodiments, the most appropriate response to the customer query may be provided to the customer on the non-enterprise related interaction channel and an interaction with the customer may be initiated on the non-enterprise related interaction channel itself as explained with reference to FIG. 3. Alternatively, the processor may be caused to provision an offer to interact with a customer support representative of the enterprise on an enterprise interaction channel. To that effect, the processor may be configured to predict the most appropriate enterprise interaction channel for the customer for continuing the interaction and thereafter effect a transitioning of an interaction channel from the non-enterprise related interaction channel to the enterprise interaction channel as explained with reference to FIG. 2.

For example, the interaction may be transitioned from a third-party messaging platform, i.e. a non-enterprise related interaction channel, to a chat console associated with the enterprise upon customer acceptance of the offer for interaction. The transitioning may be effected by passing unique identifiers (identifying the customer) along with passing of interaction context from the third-party messaging platform, i.e. from the customer's device hosting the messaging application, to the processor over a communication network. The processor may then be caused to provision a Web link in a message box of the messaging platform, which upon being accessed may cause the customer device to display the chat console associated with the enterprise to transition the interaction.

Another method for facilitating a customer interaction with an enterprise is explained with reference to FIG. 6.

FIG. 6 is a flow diagram of an example method 600 for facilitating a customer interaction with an enterprise, in accordance with another embodiment of the invention. The method 600 depicted in the flow diagram may be executed by, for example, the apparatus 200 explained with reference to FIGS. 2 to 4. Operations of the flowchart, and combinations of operation in the flowchart, may be implemented by, for example, hardware, firmware, a processor, circuitry and/or a different device associated with the execution of software that includes one or more computer program instructions. The method 600 starts at operation 602.

At operation 602 of the method 600, a query related to an enterprise is received. The query is provided by a customer of the enterprise on a non-enterprise related interaction channel. The reception of the query is performed as explained with reference to operation 502 and is not explained again herein.

At operation 604 of the method 600, one or more intentions of the customer are predicted based, at least in part, on the query. In an embodiment, for customer intention prediction purposes, one or more prediction models, which are configured to subject the query and any previously gathered information corresponding to the customer to a set of structured and un-structured data analytical models including text mining & predictive models may be utilized. Examples of the prediction models may include, but are not limited to Logistic regression, Naïve Bayesian, Rule Engines, Neural Networks, Decision Trees, Support Vector Machines, k-nearest neighbor, K-means and the like. In some embodiments, the prediction models may be utilized to predict next best action for the customer. In an embodiment, the best next action is predicted based on an analysis of the lowest effort sequence of tasks, interactions, and information that can get the customer to their intended goal.

In some embodiments, at least one of channel presence information and customer attention information may be received from the linked customer devices. The channel presence information and the channel attention information may be identified as explained with reference to FIG. 2 and is not explained again herein. Furthermore, at least one of customer location information, query timing information and the like may also be received from the non-enterprise interaction channels or directly from the linked customer devices. In at least one example embodiment, the predicted intention(s) along with information such as customer presence/attention information, location information, query timing information etc. may be used to predict best next action(s) for the customer. In at least one embodiment, the most appropriate response to the customer query may be determined based on the predicted best next action(s). In an example scenario, the predicted best next action may be to initiate a customer conversation with a customer support representative of the enterprise.

At operation 606 of the method 600, a provisioning of an offer for interaction in response to the query on the non-enterprise related interaction channel is caused based on the predicted one or more intentions of customers. The provisioning of the offer may be performed as explained with reference to FIG. 2 and is not explained again herein.

At operation 608 of the method 600, a transitioning of the interaction from the non-enterprise related interaction channel to an enterprise related interaction channel is effected upon receiving an acceptance of the offer for interaction from the customer. In at least one example embodiment, the enterprise related interaction channel for transitioning the interaction is chosen based on stored customer channel preference or prediction of appropriate interaction channel for the interaction. In an embodiment, the enterprise interaction channel is selected from among a plurality of interaction channels determined to provide maximum benefit to the customer. In an embodiment, an interaction channel determined to meet one or more predefined enterprise objectives is selected from among a plurality of interaction channels. Some non-limiting examples of the predefined enterprise objectives may include a sales objective, a service objective, an influence objective and the like. The sales objective may be indicative of a goal of increasing sales revenue of the enterprise. The service objective may be indicative of a motive of improving interaction experience of the customer, whereas the influence objective may be indicative of the motive of influencing a customer into making a purchase. The transitioning of the interaction from the non-enterprise related interaction channel to the enterprise interaction channel may be performed as explained with reference to FIGS. 2 and 5.

In an illustrative example, a passing of at least one of an authentication information (for example, information configured to facilitate customer identification and authentication) and an interaction context information (for example, information collated corresponding to the ongoing customer interaction so far) from the non-enterprise interaction channel to the enterprise interaction channel is effected. The passing of at least one of the authentication information and the interaction context information may be performed as explained with reference to FIG. 2 and is not explained herein.

Various embodiments disclosed herein provide numerous advantages. The techniques disclosed herein suggest creating an interaction ecosystem within a third party application/website such that the customer query on the third-party application/website may elicit a suitable response on the third-party application/website itself. Thus, the customer does not have to dedicatedly visit an enterprise interaction channel and seek desired information. In many example scenarios, the most appropriate response and/or interaction channel is offered to the customer in his current environment, thereby saving time and effort for the customer and greatly improving the customer's experience of interacting with the enterprise.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the apparatus 200, the processor 202, the memory 204, the I/O module 206 and the communication interface 208 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIGS. 5 and 6). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the present disclosure, as discussed above, may be practiced with steps and/or operations in a different order, and/or with hardware elements in configurations, which are different than those which, are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a processor, a query related to an enterprise, the query provided by a customer of the enterprise on a non-enterprise related interaction channel; and
causing, by the processor, a provisioning of an enterprise response to the query on the non-enterprise related interaction channel, the provisioning of the enterprise response on the non-enterprise related interaction channel, at least in part, simulating an effect of provisioning of a reply by the enterprise to the query of the customer on an enterprise interaction channel.

2. The method of claim 1, wherein the non-enterprise related interaction channel corresponds to one of a third-party website, a third-party native mobile application, a third-party messaging platform, a device-based virtual assistant application and a search engine related user interface (UI).

3. The method of claim 1, wherein the provisioning of the enterprise response comprises provisioning of an answer to the query or an offer for interaction with a customer support representative of the enterprise in reply to the query of the customer.

4. The method of claim 3, further comprising:
effecting, by the processor, a transitioning of an interaction channel from the non-enterprise related interaction channel to at least one enterprise interaction channel upon receiving an acceptance of the offer for interaction from the customer.

5. The method of claim 4, wherein the at least one enterprise interaction channel is chosen based on stored customer channel preference or prediction of appropriate interaction channel for the interaction.

6. The method of claim 1, further comprising:
receiving, by the processor, interaction data corresponding to the customer's interactions with the enterprise from one or more enterprise interaction channels; and
effecting, by the processor, storage of the interaction data corresponding to the customer's interactions.

7. The method of claim 1, further comprising:
predicting, by the processor, one or more intentions of the customer based on at least one of the query and past interaction data corresponding to the customer, the prediction of the one or more intention configured to facilitate determination of the enterprise response to be provisioned to the customer.

8. The method of claim 7, further comprising:
receiving, by the processor, at least one of channel presence information, current channel attention information and current customer location information corresponding to the customer.

9. The method of claim 8, further comprising:
predicting, by the processor, a best next action for the customer based, at least in part, on the predicted one or more intentions and the received at least one of the channel presence information, the current channel attention information and the current customer location information corresponding to the customer.

10. The method of claim 9, wherein the best next action is predicted based on at least one of corporate policy and enterprise objectives.

11. The method of claim 10, wherein an enterprise objective from among the enterprise objectives corresponds to at least one of increasing consumption of enterprise offerings and improving customer sales and service experience.

12. The method of claim 10, wherein the enterprise response is provisioned to the customer on the non-enterprise related interaction channel based on the predicted best next action.

13. The method of claim 1, wherein the customer of the enterprise corresponds to an existing user or a potential user of at least one enterprise offering.

14. The method of claim 1, wherein the query corresponds one of a text-based query and a verbal query.

15. An apparatus, comprising:
at least one processor; and
a memory having stored therein machine executable instructions, that when executed by the at least one processor, cause the apparatus to:
receive a query related to an enterprise, the query provided by a customer of the enterprise on a non-enterprise related interaction channel; and
cause a provisioning of an enterprise response to the query on the non-enterprise related interaction channel, the provisioning of the enterprise response on the non-enterprise related interaction channel, at least in part, simulating an effect of provisioning of a reply by the enterprise to the query of the customer on an enterprise interaction channel.

16. The apparatus of claim 15, wherein the non-enterprise related interaction channel corresponds to one of a third-party website, a third-party native mobile application, a third-party messaging platform, a device-based virtual assistant application and a search engine related user interface (UI).

17. The apparatus of claim 15, wherein for provisioning of the enterprise response, the apparatus is further caused to:
provision an answer to the query or an offer for interaction with a customer support representative of the enterprise in reply to the query of the customer.

18. The apparatus of claim 17, wherein the apparatus is further caused to:
effect a transitioning of an interaction channel from the non-enterprise related interaction channel to at least one enterprise interaction channel upon receiving an acceptance of the offer for interaction from the customer.

19. The apparatus of claim 18, wherein the at least one enterprise interaction channel is chosen based on stored customer channel preference or prediction of appropriate interaction channel for the interaction.

20. The apparatus of claim 15, wherein the apparatus is further caused to:
receive interaction data corresponding to the customer's interactions with the enterprise from one or more enterprise interaction channels; and
effect storage of the interaction data corresponding to the customer's interactions.

21. The apparatus of claim 15, wherein the apparatus is further caused to:
predict one or more intentions of the customer based on at least one of the query and past interaction data corresponding to the customer, the prediction of the one or more intention configured to facilitate determination of the enterprise response to be provisioned to the customer.

22. The apparatus of claim 21, wherein the apparatus is further caused to:
receive at least one of channel presence information, current channel attention information and current customer location information corresponding to the customer.

23. The apparatus of claim 22, wherein the apparatus is further caused to:
predict a best next action for the customer based, at least in part, on the predicted one or more intentions and the received at least one of the channel presence information, the current channel attention information and the current customer location information corresponding to the customer.

24. The apparatus of claim 23, wherein the best next action is predicted based on at least one of corporate policy and enterprise objectives.

25. The apparatus of claim 24, wherein an enterprise objective from among the enterprise objectives corresponds to at least one of increasing consumption of enterprise offerings and improving customer sales and service experience.

26. The apparatus of claim 24, wherein the enterprise response is provisioned to the customer on the non-enterprise related interaction channel based on the predicted best next action.

27. A computer-implemented method, comprising:
receiving, by a processor, a query related to an enterprise, the query provided by a customer of the enterprise on a non-enterprise related interaction channel;
predicting, by the processor, one or more intentions of the customer based, at least in part, on the query;
causing, by the processor, a provisioning of an offer for interaction in response to the query on the non-enterprise related interaction channel based on the predicted one or more intentions of the customer; and
effecting, by the processor, a transitioning of an interaction channel from the non-enterprise related interaction channel to an enterprise related interaction channel upon receiving an acceptance of the offer for interaction from the customer.

28. The method of claim 27, wherein the non-enterprise related interaction channel corresponds to one of a third-party website, a third-party native mobile application, a third-party messaging platform, a device-based virtual assistant application and a search engine related user interface (UI).

29. The method of claim 27, further comprising:
receiving interaction data corresponding to the customer's interactions with the enterprise from one or more enterprise interaction channels; and
effecting storage of the interaction data corresponding to the customer's interactions, wherein the one or more intentions of the customer are predicted based on at least one of the query and the stored interaction data corresponding to the customer's interaction.

30. The method of claim 27, further comprising:
receiving at least one of channel presence information, current channel attention information and current customer location information corresponding to the customer.

31. The method of claim 30, further comprising:
predicting a best next action for the customer based on the predicted one or more intentions and the received at least one of the channel presence information, the current channel attention information and the current customer location information corresponding to the customer.

32. The method of claim 31, wherein the enterprise response is provisioned to the customer on the non-enterprise related interaction channel based on the predicted best next action.
